(19) United States
(12) Patent Application Publication
(10) Pub. No.: US 2007/0078823 A1
(43) Pub. Date: Apr. 5, 2007

(54) Expression templates and object classes for multidimensional analytics expressions

(75) Inventors: Karthik Ravindran, Bellevue, WA (US); Sam Skrivan, Seattle, WA (US); Manoj Nuthakki, Redmond, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/240,121

(22) Filed: Sep. 30, 2005

(51) Int. Cl. G06F 17/30

(52) U.S. Cl. 707/3

(57) ABSTRACT

Abstract metadata representing a multidimensional database expression and parameters in the multidimensional database expression are generated. Using the metadata, a class is generated that can be used to obtain an abstract data structure for the multidimensional database expression. The obtained data structure can then be translated into a desired multidimensional query language expression string that can be executed to retrieve data from a multidimensional database.

### BACKGROUND

Relational databases consist of one or more tables that each have a plurality of columns or fields. Queries used to retrieve information from such tables are relatively straightforward to write and involve selecting one or more fields to be returned based on values in those or other fields in the tables. Relational databases have been available for a long time; so many application developers know how to write queries for relational databases.

Multidimensional databases (a more recent and fast growing development in database technologies) have been identified and accepted as being more advantageous than relational databases in data aggregation, online analytical data processing (OLAP) and end user reporting scenarios, all of which are common functional requirements in business information systems today. In multidimensional databases, data from relational databases is aggregated into a data structure known as a cube that facilitates more efficient multidimensional analysis of key business metric values across a set of defined business dimensions. A cube includes a set of Dimensions and Measures whose data values are typically sourced from relational databases. Dimensions are categories by which key business metrics can be aggregated, grouped, and analyzed (Example: A Sales amount business metric can be grouped and analyzed by dimensions like Customer, Salesperson, Sales region etc) . A Dimension has attributes (Example: A Customer dimension can contain attributes like Customer Name, State, City, Gender etc) that can be optionally organized into hierarchies that have different levels (Example: A Customer Dimension can contain a State-City-Customer hierarchy comprising the levels State, City, and Customer Name). Measures, which represent aggregated business metrics stored in the cube, can be grouped and analyzed by the cube dimensions.

Specialized query languages exist to facilitate the querying of multidimensional databases. The most common and widely accepted/implemented query language for querying multidimensional databases is MDX. MDX is primarily a specification developed and introduced by Microsoft in 1998. Microsoft proposed that MDX be a standard, and its adoption among application writers and other OLAP providers is steadily increasing. Products like Microsoft SQL Analysis Server, IBM's DB2 etc. implement MDX as their OLAP query language. There are also some multidimensional database vendors who implement and support proprietary query language syntax for querying data stored in their cube artifacts. Query languages for querying multidimensional data stored in cubes provide a rich set of functions and operators that can be used to define expressions for common analytical computations like ratios, trends, averages, time series calculations etc. Expertise in using these query languages is not a common skill and requires a fair amount of investment in training to develop (even for developers who are proficient in relational databases and the SQL query language)

The MDX language for instance has a very exacting syntax and the majority of application developers have little to no experience in using it. Writing MDX queries is time consuming, prone to errors, and a skill that takes a significant amount of time to acquire. In particular, each of the large number of MDX functions requires an exacting syntax and a strong knowledge of the underlying cube structure. For example, the function that returns the top n percent requires that a path to a set, a percent value, and a measure be provided in a particular order and with a particular syntax. Another common requirement like computing a Year to date running total of a business metric will require the use of multiple MDX functions and operators to define the related expression. The cube data members referenced by the functions also need to be specified using an exacting syntax.

A problem trend observed here is that while the analytics computational requirements (Examples: Ratios, Moving Averages, Year to date totals etc) are well known to most business application developers and users, specialized skills are required to implement their definitions in code.

Further, when used in application code, analytics expressions appear as strings in code written by application developers. These strings cannot be evaluated at compile time. As a result, if the analytics expression is incorrectly written by the application developer, an error will not appear until run time. This complicates the development of the application code and makes it more likely that a code “bug” will ship in the application. The other side effect of these expressions being coded as strings is that they will not be resilient to changes introduced to the structure of the cubes that they are based on. Breaking impact of a change to the structure of a cube referenced by an expression cannot be identified at compile time and will commonly result in runtime errors. Developers are required to execute string-based find and patch steps to fix the expressions in code, which is not an optimal process and is one that is error prone.

Though MDX was cited as an example here, these problems/challenges also apply to other proprietary multidimensional query languages.

Currently, some systems provide templates of commonly used Analytics expressions. However these templates are again simply strings. Since these templates are written without any knowledge of the underlying cube structure, the application programmer must still know all of the names of the different structural elements of the cube and enter references to them correctly into the code. Further, if the user wants to apply a template to different scenarios, he would need to create multiple instances of the template with hard coded parameter bindings for each of the measures and dimension levels. There is no easy way to define a template once and vary its parameter bindings dynamically based on need. Additionally, compile time verification and resilience to changes in the underlying cube structures continue to be issues when using these templates.

The discussion above is merely provided for general background information and is not intended to be used as an aid in determining the scope of the claimed subject matter.

### SUMMARY

Abstracted metadata is generated for multidimensional analytics expression templates. This Metadata is used to define analytics queries for an application using a design time query builder (the resulting query definitions are stored as application metadata) and to code generate strongly typed expression classes that are compiled into an expression assembly. The expression classes can be referenced and used to also define analytics queries in code. The use of strongly-typed expression classes in code enables the benefits of compile time verifications and the elimination of the usage of strings to define analytics queries in application code. The Expression assembly is used at runtime to resolve the expressions used in analytics queries. When resolving an expression, an abstract expression tree is returned by the expression assembly. This expression tree is translated to a native query language expression (Example: MDX expression) by an expression translator. Multiple expression translators can be implemented to target different multidimensional databases and query languages.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a computing environment.

FIG. 2 is a block diagram of a mobile computing environment.

FIG. 3 is a flow diagram of a method of forming and integrating analytics expressions and cube components into an application.

FIG. 4 is a block diagram of elements used in the method of FIG. 3.

FIG. 5 is a user interface for defining a new analytics expression.

FIG. 6 is an example of a user interface for constructing multidimensional database queries.

FIG. 7 is a flow diagram of a method for generating a class based on analytics expression metadata.

FIG. 8 is a block diagram of elements used to form and use assemblies that execute analytics expressions.

FIG. 9 is a flow diagram of a method of translating an analytics query.

### DETAILED DESCRIPTION

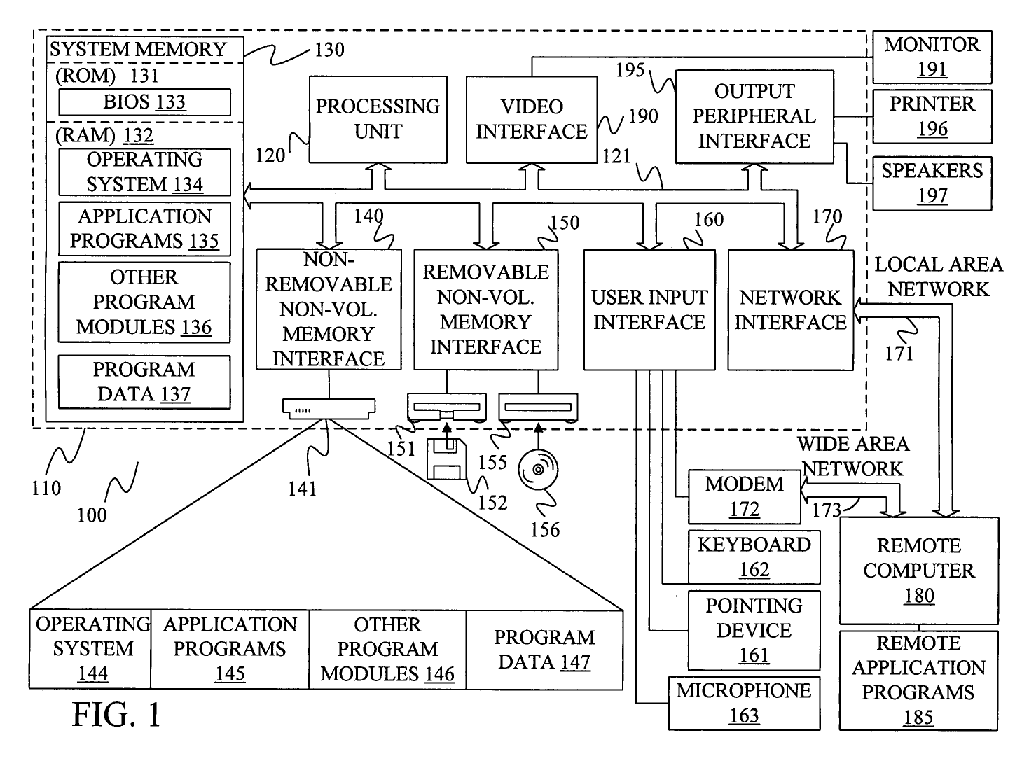

FIG. 1 illustrates an example of a suitable computing system environment 100 on which embodiments may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing some embodiments includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

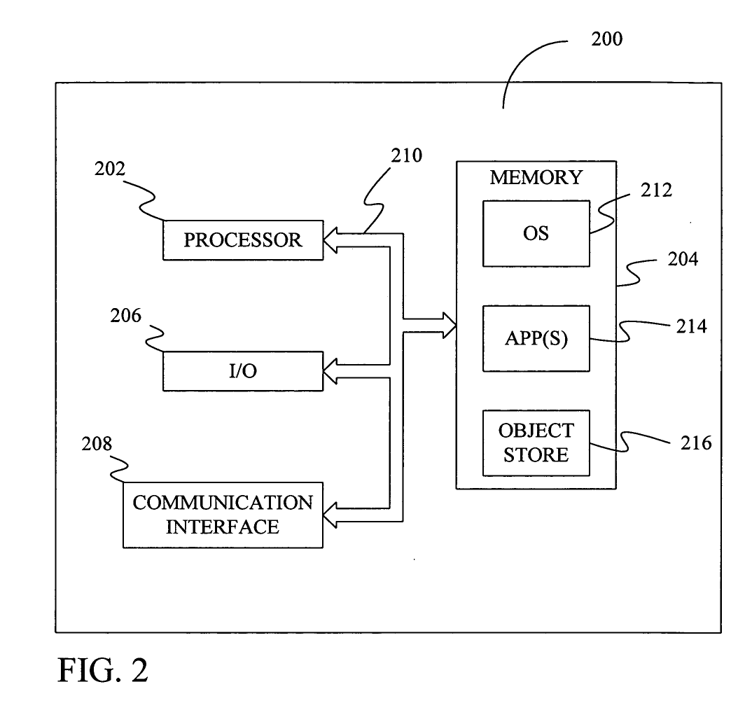

FIG. 2 is a block diagram of a mobile device 200, which is an exemplary computing environment. Mobile device 200 includes a microprocessor 202, memory 204, input/output (I/O) components 206, and a communication interface 208 for communicating with remote computers or other mobile devices. In one embodiment, the afore-mentioned components are coupled for communication with one another over a suitable bus 210.

Memory 204 is implemented as non-volatile electronic memory such as random access memory (RAM) with a battery back-up module (not shown) such that information stored in memory 204 is not lost when the general power to mobile device 200 is shut down. A portion of memory 204 is preferably allocated as addressable memory for program execution, while another portion of memory 204 is preferably used for storage, such as to simulate storage on a disk drive.

Memory 204 includes an operating system 212, application programs 214 as well as an object store 216. During operation, operating system 212 is preferably executed by processor 202 from memory 204. Operating system 212, in one preferred embodiment, is a WINDOWS® CE brand operating system commercially available from Microsoft Corporation. Operating system 212 is preferably designed for mobile devices, and implements database features that can be utilized by applications 214 through a set of exposed application programming interfaces and methods. The objects in object store 216 are maintained by applications 214 and operating system 212, at least partially in response to calls to the exposed application programming interfaces and methods.

Communication interface 208 represents numerous devices and technologies that allow mobile device 200 to send and receive information. The devices include wired and wireless modems, satellite receivers and broadcast tuners to name a few. Mobile device 200 can also be directly connected to a computer to exchange data therewith. In such cases, communication interface 208 can be an infrared transceiver or a serial or parallel communication connection, all of which are capable of transmitting streaming information.

Input/output components 206 include a variety of input devices such as a touch-sensitive screen, buttons, rollers, and a microphone as well as a variety of output devices including an audio generator, a vibrating device, and a display. The devices listed above are by way of example and need not all be present on mobile device 200. In addition, other input/output devices may be attached to or found with mobile device 200.

To make it easier for application developers to define multidimensional database analytics expressions at design time and in code, metadata descriptions of commonly used analytics expressions (in the form of expression templates) and programming object classes formed from the metadata descriptions are provided. Each expression object class generated from the metadata description will contain a method that can be invoked to return an abstract expression tree for an expression. The tree is passed to an expression translator for translation to the native query language of a target multidimensional database system. Each object class resolves expression parameter references to components of multidimensional database structures, such as measures, dimensions and levels within a cube, into full paths. Because the expression objects resolve components of multidimensional database structures into paths, application developers can define multidimensional database expressions by simply referencing the names of components in the structure's metadata (measures, dimensions, dimension attributes, hierarchies, levels) without knowing the full paths of the structural components expressed in a platform specific syntax. In addition, the reference to strongly typed structural components allows any errors in referencing the structural components to be detected at compile time rather than run time.

Although the methods and systems described herein can be practiced with any multidimensional database query language, for simplicity, the MDX query language is referenced below. In addition, although the present invention may be used with any multidimensional database structure, cube database structures are referenced below.

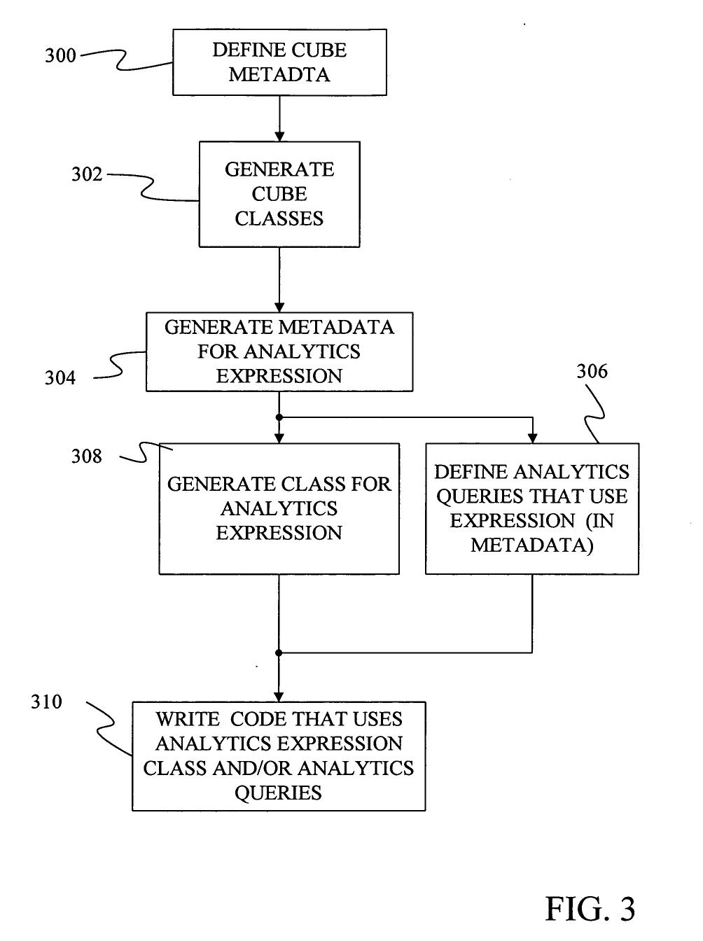

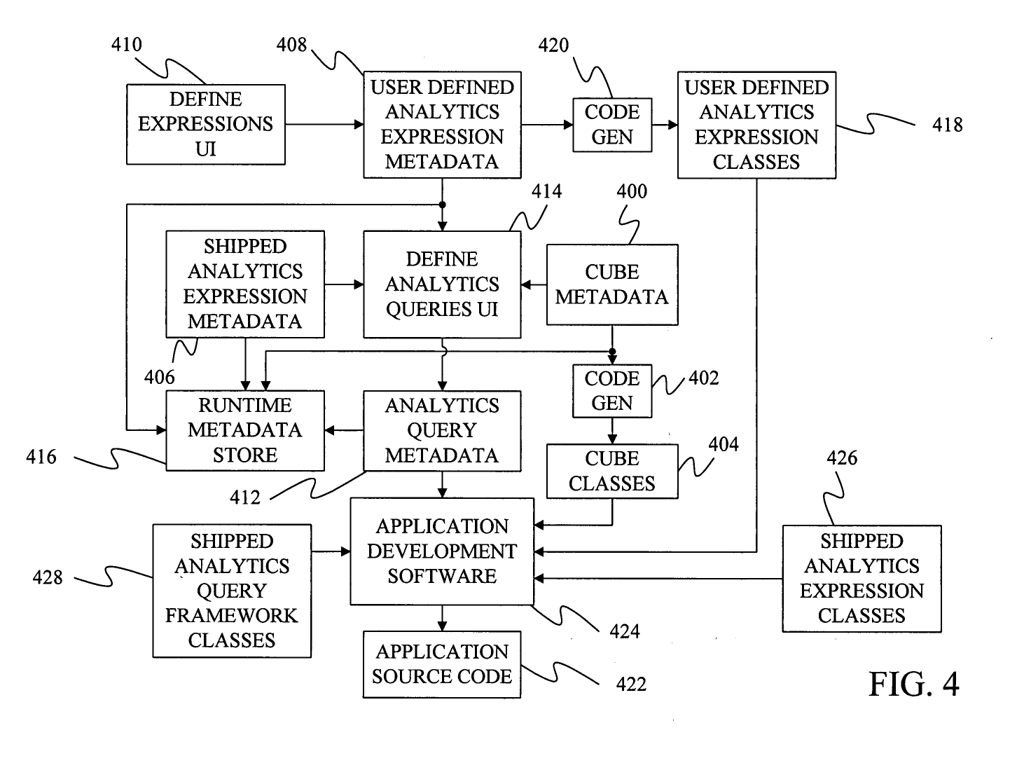

FIG. 3 provides a flow diagram of a method for constructing and using metadata definitions for analytics expression templates. FIG. 4 provides a drill down block diagram of elements used in the method of FIG. 3.

In step 300 of FIG. 3, cube metadata 400 of FIG. 4 is written which describes the structure of a cube. A cube is a multidimensional database structure that has a tree-like form in which Members are aggregated into Levels, Levels are aggregated into Hierarchies, and Hierarchies are aggregated into Dimensions. Measures, which represent values stored in the cube, can be queried at different levels of the cube's structure based on multiple Dimensions. The dimensions, dimension attributes, hierarchies, and levels represent components of the cube.

At step 302, cube metadata 400 is provided to code generation application 402. Code generation 402 converts the metadata into cube classes 404, which in one embodiment are written in C#. Typically, cube classes 404 include a primary type for the cube itself and secondary types for each Dimension in the cube. In the primary class, the Measures for the cube are exposed as properties. Nested types are provided within the Dimension types to provide for Hierarchies, Levels and Members as defined in the cube metadata. The cube classes are derived from a cube base class (not shown).

At step 304, metadata is generated for an analytics expression template. In FIG. 4, two types of metadata are shown, shipped analytics expression metadata 406 and user defined analytics expression metadata 408. Shipped analytics expression metadata 406 forms part of a software package provided to application developers. User defined analytics expression metadata 408 is analytics expression metadata produced by a developer. Under one embodiment, analytics expression metadata is written using a tagged language such as XML. For example, metadata for an analytics expression template named “YTDTotal” would have the following metadata:

<Template Name=“YTDTotal” Type=“Metric”>

<Parameters>

<Parameter Name=“Metric”

BindingType=“Measure”/>

<Parameter Name=“Calendar”

BindingType=“TimeHierarchy”/>

<Parameter Name=“Year”

BindingType=“Year”/>

</Parameters>
<Translation>

<!CDATA[Sum(PeriodsToDate({2},{1},

CurrentMember),{0})]]>

</Translation>

</Template>

where the Name attribute in the Template tag provides the name to be assigned to the class for the analytics expression and the Type attribute designates whether the analytics expression will return a single value or a set of values. In particular, “metric” is used as the type if the analytics expression will return a single aggregated numeric metric value (Example: Year To Date Sales) and “set” is used if the analytics expression will return a set of values (Example: Top 10 Customer names).

Each Parameter tag describes a parameter that forms part of the analytics expression. The Name attribute in the Parameter tags provides the name for the parameter and the Binding Type attribute in the Parameter tags describes which of a set of cube component data types the parameter belongs to. Possible cube component data types include Measure, Dimension, DimensionAttribute, Hierarchy, TimeHierarchy, Level, or Year Level. Other cube component data types are possible, with each cube component data type describing a component of the cube.

A string representation of the abstract analytics expression tree is shown between the Translation tags for readability. In an actual implementation, the expression tree would be stored as a BLOB (Binary Large Object) in the metadata and translated to a specific analytics query language like MDX by an expression translator. The numbered place holders {0}, {1} and {2} in the expression string represent parameter placeholders, which are filled with paths resolved from the parameters designated in the Parameter tags in the order in which the Parameter tags appear within the metadata. Thus, the Metric parameter would fill slot zero, the Calendar parameter would fill slot one, and the Year parameter would fill slot two in the example above.

The expression for the YTDTotal template above, utilizes an analytics function PeriodsToDate, which produces a set of Measure values with one value for each member of the YearLevel in the TimeHierarchy. The string also utilizes the function “Sum” to sum the values in the set.

Other examples of analytics expression metadata include:

<Template Name=“Ratio To Parent” Type=“Metric”>

<Parameters>

<Parameter Name=“Metric” BindingType=“Measure” />
<Parameter Name=“GroupingHierarchy”

BindingType=“Hierarchy” />

</Parameters>
<Translation>

<! [CDATA[{0}/({0},{1}.CurrentMember.Parent)]]>

</Translation>

</Template>

Which provides the ratio of a measure at one level to the aggregation of the measures determined at the parent node of the level.

Template Name=“Year Ago Difference” Type=“Metric”>

<Parameters>

<Parameter Name=“Metric”
BindingType=“Measure” />
<Parameter Name=“TimeHierarchy”

BindingType=“TimeHierarchy” />

<Parameter Name=“YearLevel”
BindingType=“YearLevel” />

</Parameters>
<Translation>

<![CDATA[iif(ParallelPeriod({2}, 1,

{1}.CurrentMember) IS NULL,
NULL,{0} − ({0},

ParallelPeriod({2}, 1,
{1}.CurrentMember)))]]>

</Translation>

</Template>

Which provides the difference for a measure between two years if there was a value for the measure the preceding year.

<Template Name=“Proportional Allocation” Type=“Metric”>

<Parameters>

<Parameter Name=“ValueToAllocate”
BindingType=“Constant”

/>

<Parameter Name=“AllocationLevel”
BindingType=“AllLevel”

/>

<Parameter Name=“AllocateBasedOn”
BindingType=“Measure” />

</Parameters>
<Translation><! [CDATA[{0} * ({2} / ( {2},{1}.[All]

))]]></Translation>

</Template>

Which allocates a value based on the percentage of a measure that is allocated to a member relative to all members associated with a parent.

<Template Name=“TopN” Type=“Set”>

<Parameters>

<Parameter Name=“Set”
BindingType=“Level|Attribute”

/>

<Parameter Name=“Count”
BindingType=“Constant” />
<Parameter Name=“Metric”
BindingType=“Measure” />

</Parameters>
<Translation>

<![CDATA[TopCount({0},{1},{2})]]>

</Translation>

</Template>

Which provides the top N members of a set ranked based on the specified metric.

<Template Name=“BottomN” Type=“Set”>

<Parameters>

<Parameter Name=“Set” BindingType=“Level|Attribute” />
<Parameter Name=“Count” BindingType=“Constant” />
<Parameter Name=“Metric” BindingType=“Measure” />

</Parameters>
<Translation>

<![CDATA[BottomCount({0},{1},{2})]]>

</Translation>

</Template>

Which provides the bottom N members of a set ranked based on the specified metric.

<Template Name=“TopNPercent” Type=“Set”>

<Parameters>

<Parameter Name=“Set” BindingType=“Level|Attribute” />
<Parameter Name=“Percent” BindingType=“Constant” />
<Parameter Name=“Metric” BindingType=“Measure” />

</Parameters>
<Translation>

<![CDATA[TopPercent({0},{1},{2})]]>

</Translation>

</Template>

Which provides the Top N % of members of a set ranked based on the specified metric

<Template Name=“BottomNPercent” Type=“Set”>

<Parameters>

<Parameter Name=“Set” BindingType=“Level|Attribute” />
<Parameter Name=“Percent” BindingType=“Constant” />
<Parameter Name=“Metric” BindingType=“Measure” />

</Parameters>
<Translation>

<![CDATA[BottomPercent({0},{1},{2})]]>

</Translation>

</Template>

Which provides the Bottom N % of members of a set ranked based on the specified metric

<Template Name=“Average” Type=“Metric”>

<Parameters>

<Parameter Name=“Metric” BindingType=“Measure” />
<Parameter Name=“Set” BindingType=“Level|Attribute” />

</Parameters>
<Translation><![CDATA[AVG({1},{0})]]></Translation>

</Template>

Which provides the average of the measures across a particular level or attribute of the cube.

<Template Name=“Rolling Average” Type=“Metric”>

<Parameters>

<Parameter Name=“Window Period”
BindingType=“Constant” />
<Parameter Name=“TimeHierarchy”

BindingType=“TimeHierarchy” />

<Parameter Name=“Metric”
BindingType=“Measure” />

</Parameters>
<Translation>

<![CDATA[Avg (LastPeriods ({0},
{1}.CurrentMember), {2})]]>

</Translation>

</Template>

Which provides a rolling average of a measure across a time hierarchy for a user specified window period

<Template Name=“% of Total (All)” Type=“Metric”>

<Parameters>

<Parameter Name=“Metric”
BindingType=“Measure” />
<Parameter Name=“Level”
BindingType=“AllLevel” />
<Parameter Name=“ParentDimension”
BindingType=“Dimension”

/>

</Parameters>
<Translation>

<![CDATA[({0},{1}.CurrentMember)/

SUM({2}.[All],{0}) * 100]]>

</Translation>

</Template>

Which provides the percentage of a measure that a member contains relative to an entire dimension.

<Template Name=“% of Parent Total” Type=“Metric”>

<Parameters>

<Parameter Name=“Metric” BindingType=“Measure” />
<Parameter Name=“Level” BindingType=“AllLevel” />

</Parameters>
<Translation>

<![CDATA[({0},{1}.CurrentMember)/

SUM({1}.CurrentMember.Parent.Children,{0}) * 100]]>

</Translation>

</Template>

Which provides the percentage of a measure that a member contains relative to the sum of the measure across all children of the parent to the member.

Abstracted analytics functions are used to define expression templates. The abstract expression trees are translated by an expression translator to a specific analytics query language at runtime. The translated analytics query is understood and executed by the analytics query language interpreter of a multidimensional database to generate the result set. These functions are shown as examples only and any analytics functions supported by the analytics query language interpreter may be used in analytics expression metadata.

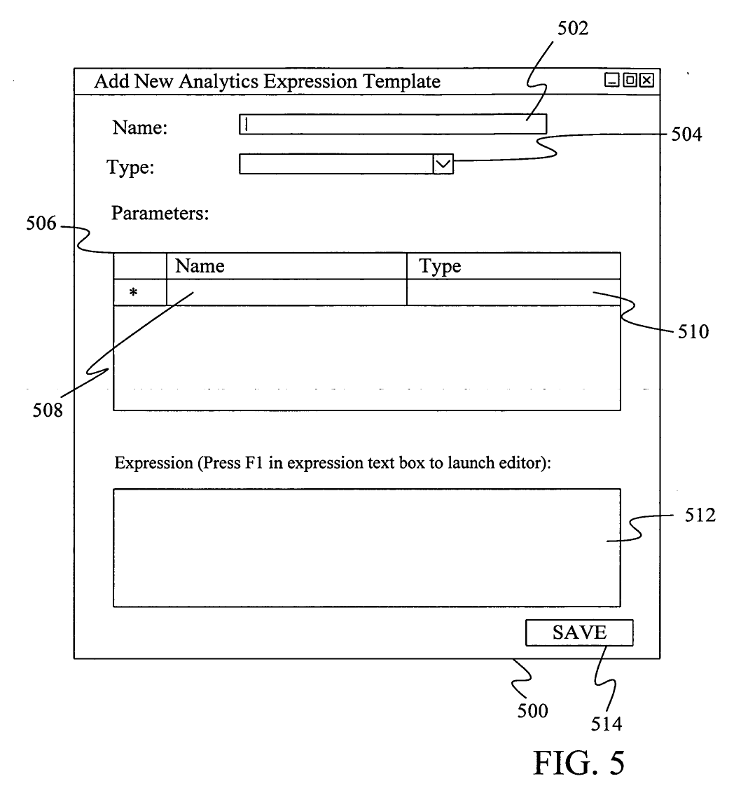

The analytics expression metadata is created using a user interface 410 such as user interface 500 of FIG. 5. User interface 500 provides a Template Expression name field 502 and a Template Expression type field 504 that allow a developer to set the Name and Type attribute of the template. Template Expression type field 504 includes a combo box that allows the user to see the two possible Template Expression types, “Metric” and “Set.”

An expandable parameter list 506 is provided with a parameter name field 508 and a type field 510. With each entry of a parameter name or type, a new row is provided to allow insertion of another parameter name and type. In text box 512, the user types in the analytics expression string with slot indicators for the parameters found in the parameter list. When save button 514 is pressed, the metadata is generated to produce an XML representation like the representations shown above. In creating the metadata from the user interface, the parameters are placed in the same order as they appear in the user interface.

After metadata 408 and 406 for the analytics expression have been generated, the metadata may be used with cube metadata 400 to generate analytics query metadata 412 that describes an analytics query at step 306. Under one specific embodiment, analytics query metadata 412 is formed using a drag-and-drop user interface that allows the developer to place cube components and expression templates in a query shell to define the query.

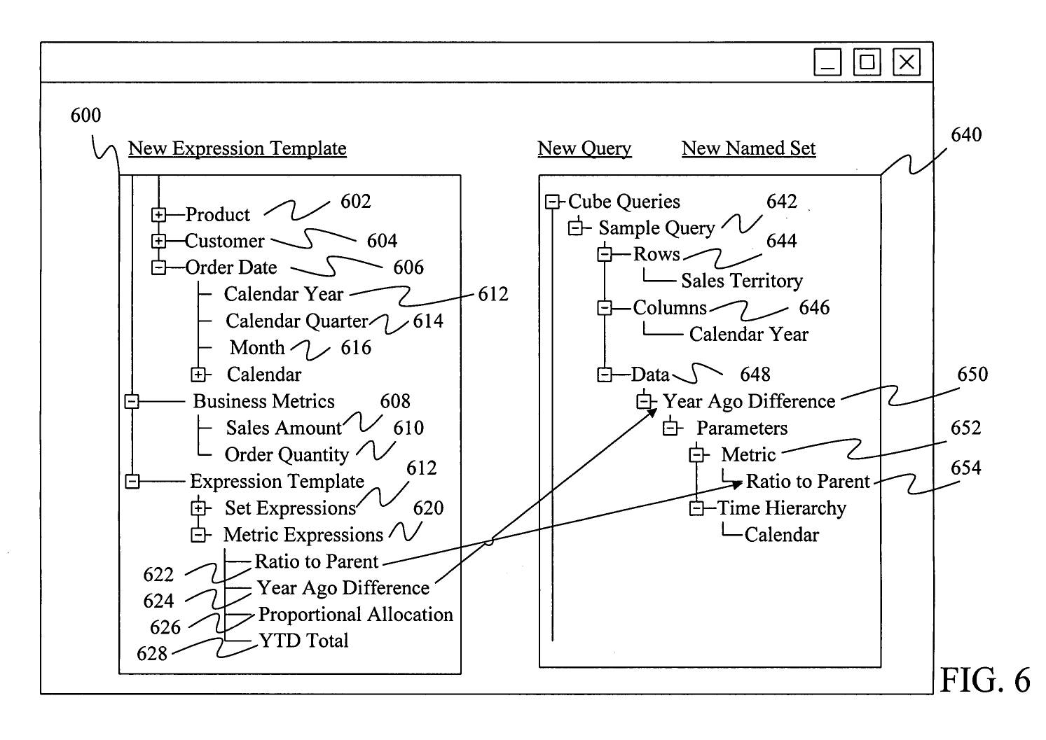

FIG. 6 provides an example of a drag-and-drop user interface that allows a developer to define an analytics query. In FIG. 6, cube components and a library of expression templates are provided in an elements pane 600. The cube components include dimensions such as Product dimension 602, Customer Dimension 604 and Order Date dimension 606 and Measures such as Sales Amount 608 and Order Quantity 610. Each dimension is expandable to show levels such as Calendar Year level 612, Calendar Quarter level 614, and Month level 616 of Order Date dimension 606. The expression templates are organized into Set expressions 618 and Metric expressions 620 and include expressions defined in shipped analytics expression metadata 406 and user-defined analytics expression metadata 408. In FIG. 6, metric expression templates Ratio-to-Parent 622, Year Ago Difference 624, Proportional Allocation 626, and YTD Total 628 are shown.

Each of the cube components and expressions shown in pane 600 may be selected, dragged, and dropped into a query shell in query pane 640. A query shell is a user interface element that consists of a query name, such as Sample Query 642, a Rows header, such as Rows header 644, a Columns header, such as Columns header 646, and a Data header such as data header 648. Cube components may be dragged/moved into the Rows and Columns headers. For example, the Calendar year level 612 has been dragged into Columns header 646. Measures and expression templates may be dragged/moved into the data header and into expression templates previously placed in the data header. For example, Year Ago Difference expression template 624 has been dragged into data header 648 in FIG. 6. The metadata for Year Ago Difference includes two parameters, one of type “Metric” and one of type “Time Hierarchy”, which appear beneath Year Ago Difference header 650 in query pane 640.

In FIG. 6, expression template Ratio to Parent 622 has been dragged onto “Metric” parameter 652 of the Year Ago Difference expression template. Thus, an expression template may be inserted within another expression template as a parameter value. Although not shown, Ratio to Parent entry 654 in query pane 640 can be expanded to show the parameters of the Ratio to Parent expression template. Cube components and expression templates that are of the correct type can then be dragged onto those parameters to further define the query.

When an element is moved from elements pane 600 to the query shell, the metadata definition for the element is inserted into the metadata definition for the query. Thus, when a cube component is moved onto the query shell, the metadata for that component is inserted into the query metadata. Similarly, when an analytics expression is moved onto the query shell, the metadata for the expression is inserted into the metadata for the query.

The queries defined through the analytics queries user interface 414 are stored as analytics query metadata 412. This metadata defines the name of the query, the dimensions, hierarchies, levels or sets defined for the rows and columns of the query, and the measures and expression templates defined for the data of the query.

Analytics query metadata 412 is stored along with user-defined analytics expression metadata 408, shipped analytics expression metadata 406 and cube metadata 400 in a runtime metadata store 416 which can be accessed during runtime to resolve queries.

In addition to using user-defined analytics expression metadata 408 to define analytics queries, the method of claim 3 uses the metadata to generate user-defined analytics expression classes 418 at step 308. Specifically, user-defined analytics expression metadata 408 is provide to code generation 420 to form user-defined analytics expression classes 418.

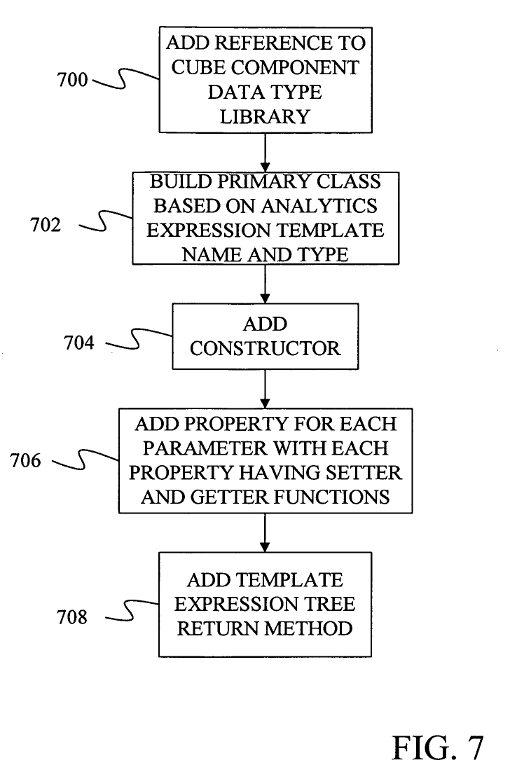

FIG. 7 shows a flow diagram of the process represented by step 308. In step 700, a reference to the cube component data type library is written to an output file that will contain the analytics expression class. The cube component data type library contains base classes for the cube data types such as Measure, Dimension, DimensionAttribute, Hierarchy and Level. At step 702, a primary class is written and is given the name set in the Name attribute of the template tag of the analytics expression metadata. This class derives from one of two classes either AnalyticsMetricTemplate or AnalyticsSetTemplate. AnalyticsMetricTemplate will be used as the base class if the type for the template is “metric.” AnalyticsSetTemplate will be used as the base class if the type of the template is “set.”

At step 704, private fields are defined for each parameter in the metadata. At step 706, a constructor method is written to the class. Under one embodiment, the constructor includes a parameter for each parameter defined in the metadata. In other embodiments, the constructor is overloaded by writing different versions of the constructor with different numbers of parameters. This allows the constructor to be called with different numbers of parameters. Within the constructor, setter functions are called for each parameter that is passed in.

At step 708, a property is formed for each parameter in the metadata. Each property includes setter and getter functions that respectively set the corresponding private field for the parameter equal to the value that the property is being set to and return the value of the property. The property is given the same name as the name attribute in the parameter of the metadata.

At step 710, a method to obtain an expression tree for the analytics expression template is added to the class. Under one embodiment, this method uses the name of the analytics expression template to locate the metadata for the analytics expression template. Using the metadata, the method constructs an expression tree, which is an abstract expression data structure containing the elements of the analytics expression template. This expression tree is an abstraction of the analytics expression in that it is not defined using any particular query language syntax. In order to produce a query string that represents the analytics expression, this abstract expression tree must be translated into a desired analytics query language string as described further below. Because the expression tree is an abstraction, many different translators may be written such that each translator would produce a different string with syntax for a different query language given the same expression tree.

Below is an example of an analytics expression class that is formed from the analytics metadata shown above for the YTDTotal function.

using CubeMetadatTypeLib;
class YTDTotal: AnalyticsMetricTemplate
{

private Measure _metric;
private TimeHierarchy _calendar;
private YearLevel _year;

public YTDTotal(Measure metric, TimeHierarchy
calendar)
{

Metric = metric;
Calendar = calendar;

}
public property Measure Metric
{

set{_metric = value;}
get{ return _metric; }

}
public property TimeHierarchy Calendar
{

set
{

_calendar = value;
Year = calendar.yearLevel;

}
get { return _calendar; }

}

public property YearLevel Year

{

set{_year = value;}
get { return _year; }

}
public MBFExpressionTree GetExpressionTree( )
{

| | |
|---|---|
| return | MBFExpression.LoadTemplateMetadata(“YTD |

Total”).GetExpression ;
}

At step 310 of FIG. 3, the analytics expression classes 418 and/or the analytics query metadata 412 is used to write application source code 422. In particular, a developer uses application development software 424 to write application source code 422. Application development software uses user defined analytics expression classes 418, analytics query metadata 412, cube classes 404 and shipped analytics expression classes 426 and shipped analytics query framework classes 428 to assist the developer in writing application source code 422. Shipped analytics expression classes 426 represent expression classes formed from shipped analytics expression metadata 406. Shipped analytics query framework classes 428 provide classes and methods for loading and executing analytics queries.

In some embodiments of application development software 424, an auto-complete feature is provided that provides a list of available object extensions when an object class is typed into application source code 422 followed by a period. For example, if “Salescube.” was entered, the auto-complete feature would provide a list of subordinate types found within that class. Thus, for a cube object, the dimensions and hierarchies would be shown. This allows the programmer to select from a list of available sub-types and thus does not require the programmer to know or key in the components of the cube, or properties or methods of an analytics expression. Application development software 424 can also validate objects as they are written to application source code 422 to ensure that they correspond to a defined object in one of the classes.

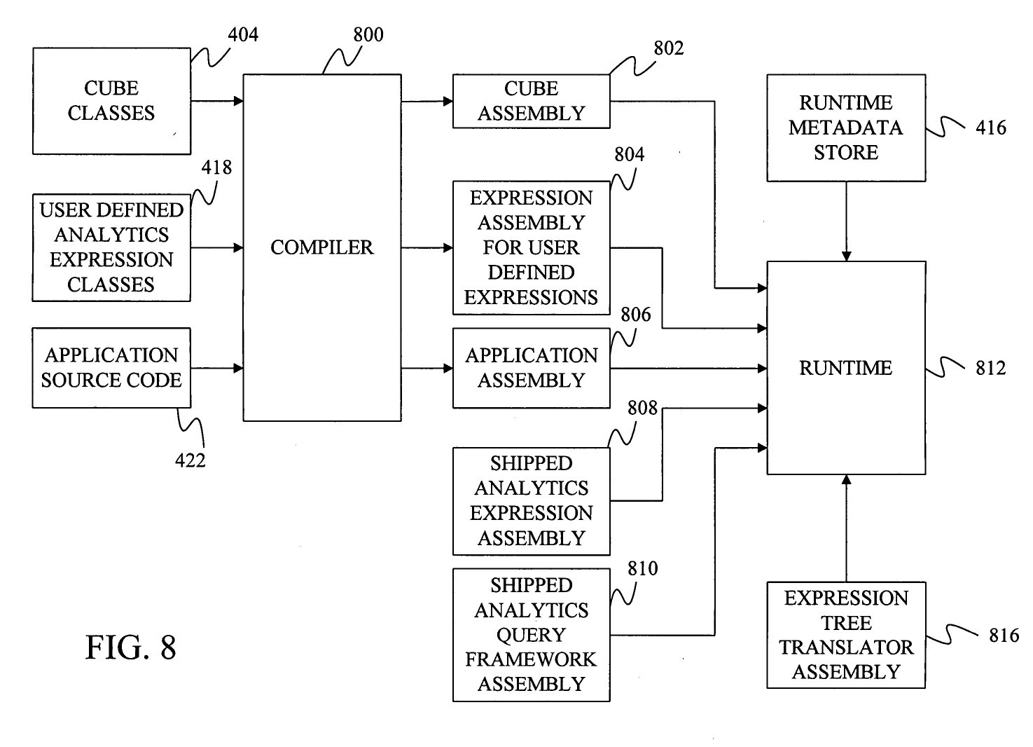

As shown in FIG. 8, application source code 422, user-defined analytics expression classes 418 and cube classes 404 are compiled by a compiler 800 to form application assembly 806, expression assembly 804, and cube assembly 802, respectively. During the compilation, compiler 800 validates the application source code based on the user-defined analytics expression classes, the shipped analytics expression classes, the shipped analytics query framework classes, the cube classes and the query metadata.

Since the analytics expressions are now strongly typed classes, and can accept references to the cube component data types, compiler 800 can determine if the references to the analytics expressions and the cube components are valid. If the references to the cube component data types or the analytics expressions are not valid, the compiler returns an error for the application source code. Compiler 422 can also check the calls used to set the values for the parameters in the expression, either the constructor calls or the parameter property calls, and can return a compile error if these calls are invalid. In particular, a compile error can be returned if the wrong cube component data type is being passed in a call based on the expected cube component data types defined in the expression class.

During a runtime 812, compiled code in application assembly 806 is executed. This code uses objects defined in cube assembly 802, user-defined analytics expressions assembly 804, shipped analytics expression assembly 808 and shipped analytics query framework assembly 810. Runtime 812 also makes use of runtime metadata store 814 and expression tree translator assembly 816.

Specifically, during runtime 812, when code in application assembly 806 encounters an analytics expression, it requests the expression tree for the expression from the expression's corresponding assembly in user-defined expression assembly 804 or shipped analytics expression assembly 808. This is done using the GetExpressionTree method of the expression's class. Runtime 812 then calls an expression tree translator in expression tree translator assembly 816 to obtain a string from the expression tree. Note that different translators can be provided for different query languages such that a single expression tree can be translated into different query languages depending on the translator that is used. After the query string has been formed, it is executed.

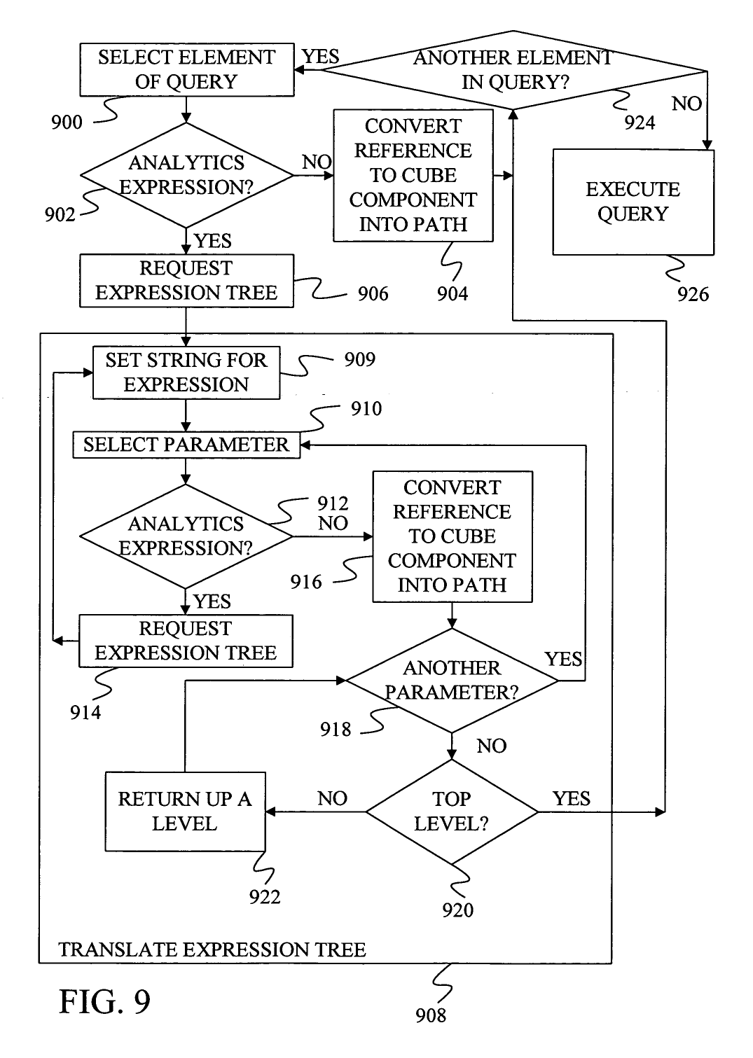

Similarly, database queries that are encountered during runtime 812 are converted into strings and then executed. FIG. 9 provides a flow diagram of a method of converting a multidimensional database query into a string.

Before executing such a query, the metadata describing the query is first loaded. In some embodiments, this involves loading the metadata from metadata store 416. Once the metadata has been loaded, conversion of the query begins at step 900 where an element of the query is selected such as the Rows, Columns, or Data.

At step 902, the expression or variable found in the selected element is evaluated to determine if it is an analytics expression. If it is not an analytics expression, it is a cube component such as a Dimension, Hierarchy, Level or Measure. At step 904, the reference to the cube component is converted into a path string that identifies the cube component using the proper syntax for the query language. The method then continues at step 924 where the query metadata is examined to determine if there are more elements to process. If there are more elements, the process returns to step 900 to select the next element of the query.

If a selected element of the query is an analytics expression, an expression tree for the expression is requested at step 906. Typically, this is done using the GetExpressionTree method found in the class for the analytics expression.

At step 908, the expression tree is translated to obtain a string representing the analytics expression written in the proper syntax for the query language of interest. This is done by applying the expression to an expression tree translator, such as found in expression tree translator assembly 816.

As shown in FIG. 9, translating an expression tree is a recursive process under some embodiments. In particular, at step 909 of the translation process, a string representing the current analytics expression with slots for parameters is set. This string meets the syntax requirements of the query language. At step 910, a parameter of the current analytics expression is selected. At step 912, the parameter is examined to determine if it is an analytics expression. If it is an analytics expression, the expression tree for that expression is requested at step 914. The process then recursively sets this new analytics expression as the current analytics expression and returns to step 909 where it sets a string for the new analytics expression in the appropriate parameter slot of the parent analytics expression. The process then selects the first parameter of expression tree returned in step 914 at step 910.

If a parameter is not an analytics expression at step 912, the parameter is a cube component. This cube component is converted into a path string that identifies the cube component using the proper syntax for the query language at step 916. This string is inserted into the appropriate slot of the current expression string. At step 914, the process determines if there are more parameters for the current expression tree. If there are more parameters, the next parameter is selected at step 910.

When there are no more parameters for the current expression tree, the process determines if it is at the top level of the recursion. If it is not at the top level of the recursion, expression trees above the current expression tree have not been completely processed. As such, the process returns up a level in the recursion at step 922 by setting the expression tree directly above the current expression tree as the current expression tree. The process then determines if there are more parameters in the new current expression tree by returning to step 918.

When the top level of the recursion is reached at step 920, the expression tree translation is complete and a full expression string has been formed from the analytics expression tree requested at step 906. The process then returns to step 924 to determine if there are more query elements to process. When there are no more query elements to process, the complete query string is executed at step 926.

Application source code 422 can include instructions to load and execute queries defined in analytics query metadata 412 or instructions that define a new analytics query and that bind parameter values to the query. Instructions that load and execute a query defined in metadata using the shipped analytics query framework classes. Specifically, the following instructions load and execute a query stored in metadata:
CubeQuery q=new CubeQuery( )
q.Load(“Sales Query”)
q.execute
In these instructions, the Load method of the CubeQuery framework class is used to load the query named “Sales Query” found in analytics query metadata 412. The instruction “q.execute” executes the query.

Instructions that define a new query and bind parameter values to the query use the cube classes and the analytics expression classes to define the elements of the query. The following example instructions define a new query and assign values to the parameters of the query.
using Analytics.Templates;
CubeQuery q=new CubeQuery(SalesCube);
q.Rows.Add(SalesTerritory);
q.Columns.Add(OrderDate.Quarter);
q.Data.Add(YTDTotal(SalesCube.SalesAmount, SalesCube.OrderDate)
q.execute

These instructions associate the SalesTerritory dimension of the SalesCube cube with the Rows of the query and the OrderDate.Quarter level with the Columns of the query. The Data of the query is set using a call to the constructor of the YTDTotal analytics expression class. This constructor call includes parameter values for the two parameters of the YTDTotal analytics expression, where Salescube.Orderdate indicates the Time Hierarchy Orderdate, and Salescube.Salesamount indicates the measure in Salescube that is to be summed in the year-to-date expression.

The values for the Parameters can alternatively be set by calling properties of the expression class. For example, the instruction: “YTDTotal.Year=Salescube.Orderdate.Year” could be used to set the Year Parameter in the YTDTotal class.

The application code can also include instructs that use a set returned through the execution of an analytics expression directly in a relational database query to restrict relational data access based on aggregate analytics data. For example:
Select Customer.CustomerID IN

(Top10(SalesCube.Customer.CustomerID,

SalesCube.Salesamount,

Salescube.OrderDate.CurrentYear))

The analytics expression Top10 returns a set of ten customer ID's and associated sales amounts associated with the top ten sales amounts aggregated over the current year. The relational query Select statement is then performed on just the set of ten customer ID's to return just the customer ID's. This integration between the results returned by an analytics expression and a relational database query are possible because the analytics expression is strongly typed as either a set or a metric. As such, a reference to an analytics expression class will be considered valid by the compiler when it compiles the relational database query.

When an analytics expression template is specified in isolation (without the context of a cube query) as above, the analytics query framework will auto-generate a cube query with a single axis to project the result set generated by resolving the expression template. This scenario can be enabled by integrating the relational and analytics query frameworks to recognize and resolve individual parts of an overall query.

The metrics or sets returned by the execution of an analytics expression can also be integrated directly into another analytics expression. For example, in:

Top10(SalesCube.Customer.CustomerID, YearAgoDifference(SalesCube.SalesAmount, SalesCube.OrderDate.CurrentYear))

Top10 and YearAgoDifference are both analytics expressions defined by object classes as described above. YearAgoDifference provides a metric that measures the difference between SalesAmounts for the current year and the preceding year. This metric is then used to select the customer ID's of the ten customers with the largest gain in SalesAmount over the last year. Once again, because the analytics expression itself is typed, the compiler will consider the direct embedding of an analytics expression valid.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for defining an analytics query, the method comprising:
inserting a metadata definition of a component of a multidimensional database structure into a metadata definition for the analytics query; and
inserting a metadata definition for an analytics expression into the metadata definition for the analytics query.

2. The method of claim 1 wherein the metadata definition for the analytics expression comprises at least one parameter used in the analytics expression.

3. The method of claim 2 further comprising setting a value for a parameter in the analytics expression.

4. The method of claim 3 wherein setting a value for a parameter in the analytics expression comprises inserting a metadata definition for another analytics expression as the value for the parameter.

5. The method of claim 3 wherein setting a value for a parameter in the analytics expression comprises inserting a metadata definition for a component of a multidimensional database structure as the value for the parameter.

6. The method of claim 1 wherein inserting a metadata definition for an analytics expression comprises selecting an analytics expression from a library of metadata definitions for analytics expressions.

7. The method of claim 1 wherein inserting a metadata definition for an analytics expression comprises forming metadata for an analytics expression and inserting the formed metadata.

8. The method of claim 1 wherein inserting a metadata definition for an analytics expression comprises:
generating a user interface element based on the metadata definition for the analytics expressions;
generating a user interface element for the analytics query;
receiving an indication that the user interface element for the analytics expression should be moved onto the user interface element for the analytics query; and
modifying the user interface element for the analytics query to show a representation of the analytics expression.

9. A computer-implemented method comprising:
generating metadata representing a multidimensional database expression and parameters in the multidimensional database expression; and
generating an expression class from the metadata.

10. The method of claim 9 wherein generating metadata comprises:
providing a user interface to accept a multidimensional database expression and parameters associated with the expression; and
using the multidimensional database expression and parameters to generate the metadata.

11. The method of claim 9 wherein generating metadata for parameters in the multidimensional database expression comprises providing a reference to a multidimensional database component data type.

12. The method claim 11 further comprising defining a multidimensional query by referencing the expression class.

13. The method of claim 11 wherein generating a class comprises writing setter and getter functions for each parameter.

14. The method of claim 11 wherein generating a class comprises providing a method in the class to return an abstract expression data structure that represents the database expression.

15. The method of claim 14 further comprising providing a translator that is capable of translating an expression data structure into a desired analytics query language string.

16. A computer-readable medium having computer-executable instructions for performing steps comprising:
requesting an expression data structure representative of an analytics expression;
applying the expression data structure to a translator to obtain an analytics expression string; and
executing the analytics expression string to obtain data from a multidimensional database.

17. The computer-readable medium of claim 16 further comprising applying the expression data structure to a second translator to obtain a second analytics expression string, the second analytics expression string having a different syntax than the analytics expression string.

18. The computer-readable medium of claim 16 wherein requesting an expression data structure comprises calling a method in a class defined for the analytics expression.

19. The computer-readable medium of claim 16 wherein the expression data structure includes a reference to a different analytics expression.

20. The computer-readable medium of claim 16 wherein the expression data structure is formed based on metadata that describes the analytics expression.
